(19) United States
(12) Patent Application Publication
(10) Pub. No.: US 2020/0043049 A1
(43) Pub. Date: Feb. 6, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Hiroyasu HADANO, Toyota-shi (JP); Yusuke KANEKO, Toyota-shi (JP); Jun GOTO, Toyota-shi (JP); Hiroko TSUJIMURA, Gifu-shi (JP); Miho OTSUKA, Nagoya-shi (JP); Hideo HASEGAWA, Nagoya-shi (JP)

(73) Assignee: TOYOTA JIDOSHA KABUSHIKI KAISHA, Toyota-shi (JP)

(21) Appl. No.: 16/507,238

(22) Filed: Jul. 10, 2019

(30) Foreign Application Priority Data
Aug. 3, 2018 (JP) 2018-146777

(51) Int. Cl. G06Q 30/02; G07C 5/08

(52) U.S. Cl. CPC G06Q 30/0265; G07C 5/085

(57) ABSTRACT

An information processing apparatus is provided with a controller. The controller is configured to execute: displaying an advertisement on an outer surface of a vehicle; determining whether there has occurred an event affecting the running of the vehicle, based on measurement information obtained from a sensor mounted on the vehicle or an external sensor arranged outside the vehicle; and changing a display mode of the advertisement in cases where it is determined that the event has occurred.

### CROSS-REFERENCE TO RELATED APPLICATIONS

This application claims the benefit of Japanese Patent Application No. 2018-146777, filed on Aug. 3, 2018, which is hereby incorporated by reference herein in its entirety.

### BACKGROUND

### Technical Field

The present disclosure relates to an information processing apparatus, an information processing method, and a non-transitory storage medium.

### Description of the Related Art

In recent years, various kinds of vehicles such as a bus, an electric train and so on is utilized for advertisement in various forms. Patent literature 1 discloses, as a technique of distributing advertisements to a vehicle in an effective manner, a vehicular advertisement distribution system which distributes advertisements only to a vehicle which is predicted to stop at a red traffic light. In addition, in the patent literature 1, information on institutions according to a driver need, a driver state, and a vehicle state, which are received from the vehicle, is distributed.

### CITATION LIST

### Patent Literature

Patent Literature 1: Japanese patent application laid-open publication No. 2009-122034

### SUMMARY

The present disclosure has for its object to provide a technique of utilizing an outer surface of a vehicle as an advertising medium in an effective manner by controlling the display mode of an advertisement to be displayed on the outer surface of the vehicle according to an event affecting the running of the vehicle.

A first aspect of the present disclosure can be perceived as an information processing apparatus which is provided with a controller including at least one processor. In case that, the controller may be configured to execute:

displaying an advertisement on an outer surface of a vehicle;

determining whether there has occurred an event affecting the running of the vehicle, based on measurement information obtained from a sensor mounted on the vehicle or an external sensor arranged outside the vehicle; and

changing a display mode of the advertisement in cases where it is determined that the event affecting the running of the vehicle has occurred.

A second aspect of the present disclosure can be perceived as an information processing method. In that case, the information processing method according to the present disclosure may be made to cause a computer to execute:

a step of displaying an advertisement on an outer surface of a vehicle;

a step of determining whether there has occurred an event affecting the running of the vehicle, based on measurement information obtained from a sensor mounted on the vehicle or an external sensor arranged outside the vehicle; and

a step of changing a display mode of the advertisement in cases where it is determined that the event affecting the running of the vehicle has occurred.

A third aspect of the present disclosure can be perceived as an information processing program or a non-transitory storage medium stored with the information processing program. In case that, the information processing program may be configured to make to cause a computer to execute:

a step of displaying an advertisement on an outer surface of a vehicle;

a step of determining whether there has occurred an event affecting the running of the vehicle, based on measurement information obtained from a sensor mounted on the vehicle or an external sensor arranged outside the vehicle; and

a step of changing a display mode of the advertisement in cases where it is determined that the event affecting the running of the vehicle has occurred.

According to the present disclosure, it is possible to provide a technique of utilizing an outer surface of a vehicle as an advertising medium in an effective manner by controlling the display mode of an advertisement to be displayed on the outer surface of the vehicle according to an event affecting the running of the vehicle.

### BRIEF DESCRIPTION OF THE DRAWINGS

FIG. 1 is a view illustrating an example of the hardware configuration of an information processing apparatus.

FIG. 2 is a view illustrating an example of the functional configuration of an information processing apparatus.

FIG. 3 is a flow chart illustrating an example of a flow of display control processing according to a first embodiment of the present disclosure.

FIG. 4 is a view illustrating an example of an advertisement information table.

FIG. 5 is a view illustrating an example of a measurement information table.

FIG. 6 is a flow chart illustrating an example of a flow of display control processing according to a second embodiment of the present disclosure.

FIG. 7 is a view illustrating an example of an advertisement information table according to the second modification.

FIG. 8 is a view illustrating an example of a correspondence relation definition table between an inter-vehicle distance and an advertising display mode.

### DESCRIPTION OF THE EMBODIMENTS

An advertisement displayed on an outer surface of a vehicle during running can be seen by occupants of passing vehicles running in the surroundings of the vehicle, as well as passers-by walking therearound, so it becomes possible to make effective distribution of the advertisement. However, the drivers of the passing vehicles or the passers-by may pay close attention to the advertisement displayed on the outer surface of the vehicle, in particular on a rear surface of the vehicle, thereby giving rise to fears that an event affecting the running of the vehicle may occur.

In view of the above, this embodiment provides an information processing apparatus (computer) configured to change a display mode of an advertisement in cases where it is determined that there has occurred an event affecting the running of the vehicle which displays the advertisement on its outer surface. The advertisement displayed on the outer surface of the vehicle is not limited to an advertisement of restaurants, amusement facilities, etc., but can include a variety of kinds of information such as traffic information, sightseeing information, weather, congestion of institutions, and so on. The vehicle may be a general vehicle, besides public transportation such as a bus, a taxi or the like, and an advertisement vehicle. The outer surface of the vehicle includes a front surface, a rear surface, and right and left side surfaces of the vehicle, but when the advertisement is displayed on the rear surface, advertising effectiveness with respect to the crew members of the following vehicle will be improved.

The information processing apparatus obtains, from a sensor mounted on the vehicle or an external sensor arranged outside the vehicle, measurement information for determining whether there has occurred an event affecting the running of the vehicle. As the sensor mounted on the vehicle, there can be mentioned, for example, a vehicle mounted camera, a distance sensor, or a millimeter wave radar, which detects objects around the vehicle, as well as an acceleration sensor or a gyro sensor, which measures the running condition of the vehicle. The information processing apparatus can obtain as the measurement information from the sensor mounted on the vehicle, information on the speed and acceleration of the vehicle, an inter-vehicle distance between the vehicle (own vehicle) and the following vehicle, or an obstacle detected around the vehicle, for example.

The external sensor arranged outside the vehicle is, for example, a roadside sensor which is arranged on the road side for detecting passing vehicles, the state of a road surface, etc. The information processing apparatus can obtain as the measurement information from the external sensor, information on traffic congestion, information on the state of a road surface (e.g., freezing, snow cover, etc.), or the like, for example. The information processing apparatus determines, based on the measurement information thus obtained, whether an event affecting the running of the vehicle has occurred.

As the event affecting the running of the vehicle, there can be mentioned, for example, the following events: the vehicle has been braked suddenly; a traffic congestion or an obstacle has been detected in front of the vehicle; or a rate of decrease per unit time of the inter-vehicle distance between the vehicle and the following vehicle has become equal to or larger than a threshold value. The information processing apparatus may calculate the degree of influence due to an event around the vehicle from the measurement information, and may determine, based on the degree of influence thus obtained, whether an event affecting the running of the vehicle has occurred. The degree of influence can be calculated, for example, by scoring an event affecting the running of the vehicle according to a measured value of each of a plurality of sensors, and obtaining a sum total of marks thus scored from the plurality of sensors.

The information processing apparatus changes the display mode of the advertisement, in cases where it is determined that an event affecting the running of the vehicle has occurred. As the change of the display mode, there can be mentioned, for example, the following: the display of the advertisement is interrupted; the attention to be paid to the event affecting the running of the vehicle is displayed; or the size of the display of the advertisement is changed. To change the size of the display includes changing the size of the entire advertisement, and changing the size of the content of the advertisement, e.g., the size of characters.

According to this embodiment, the information processing apparatus changes the display mode of an advertisement to be displayed on the outer surface of a vehicle, in cases where it is determined that an event affecting the running of the vehicle has occurred. By changing the display mode of the advertisement, the information processing apparatus can bring attention about a surrounding situation to the driver of the following vehicle or passers-by. In addition, in cases where an event affecting the running of the vehicle has not occurred, the information processing apparatus can distribute the advertisement in an effective manner, by making use of the outer surface of the vehicle as an advertising medium.

### First Embodiment

(Hardware Configuration)

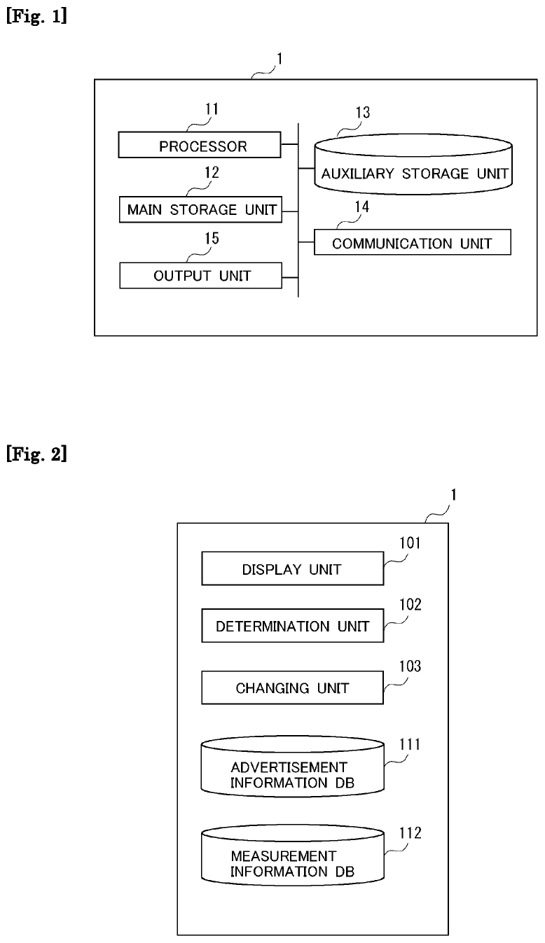

FIG. 1 is a view illustrating an example of the hardware configuration of an information processing apparatus. The information processing apparatus denoted by 1 is composed of a computer, a workstation or the like. The information processing apparatus 1 may be a computer mounted on a vehicle, in order to control a display on an outer surface of the vehicle. Such a computer has a processor 11 such as a CPU, a DSP or the like, a main storage unit 12 such as a read-only memory (ROM), a random-access memory (RAM) or the like, an auxiliary storage unit 13 such as an EPROM, a hard disk drive (HDD), removable media or the like, and a communication unit 14 for communicating with sensors mounted on the vehicle or external sensors arranged outside the vehicle or other devices. Here, note that an operating system (OS), various kinds of programs, various kinds of tables, etc., are stored in the auxiliary storage unit 13, wherein individual functional units configured to achieve predetermined objects to be described later can be achieved by loading the programs stored there to a working area of the main storage unit 12, executing them, and controlling individual component units or parts through the execution of the programs. However, a part or all of the functional units may be achieved by a hardware circuit(s) such as an ASIC, an FPGA, or the like. Here, note that the information processing apparatus 1 is not limited to the case where it is achieved by a single physical configuration, but may be configured by a plurality of computers which mutually cooperate with one another. The communication unit 14 can obtain measurement information from sensors mounted on the vehicle or external sensors arranged outside the vehicle through networks which include short-distance radio communications, road-to-vehicle communications, etc. An output unit 15 is arranged on the outer surface of the vehicle, and is a means for presenting an advertisement stored in the auxiliary storage unit 13 or an advertisement obtained from an external server, and it is, for example, an electronic bulletin board, an electronic billboard, a video billboard, a liquid crystal display, or the like.

(Functional Configuration)

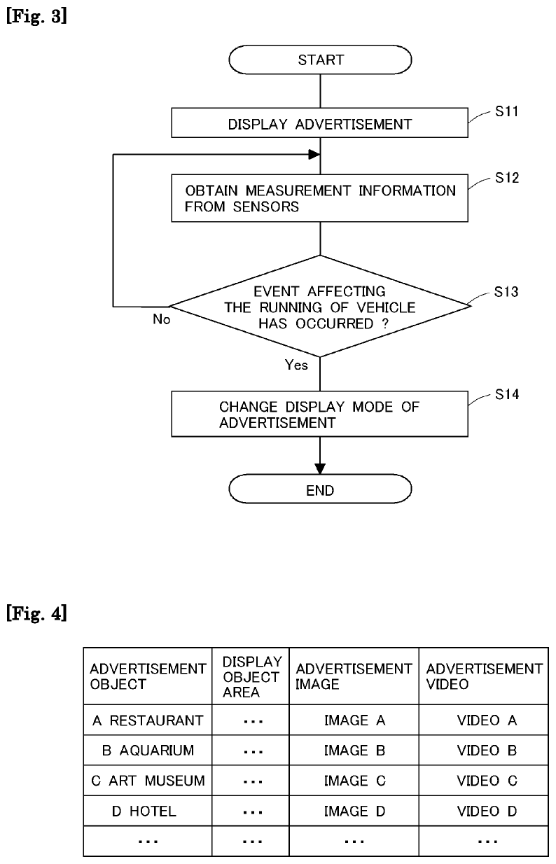

FIG. 2 is a view illustrating an example of the functional configuration of the information processing apparatus 1. The information processing apparatus 1 achieves the functions illustrated in FIG. 2, by loading a program stored in the auxiliary storage unit 13 to the main storage unit 12 and executing it by means of the processor 11. That is, the information processing apparatus 1 includes a display unit 101, a determination unit 102, a changing unit 103, an advertisement information database (DB) 111, and a measurement information database (DB) 112. The advertisement information database 111 and the measurement information database 112 are built by a program in a database management system which is executed by the processor 11 so as to manage the data stored in the auxiliary storage unit 13. The advertisement information database 111 and the measurement information database 112 are each a relational database, for example. The details of these functional units will be explained below in detail with reference to the following flow chart. In addition, the processor 11 configured to execute the program thereby to achieve these functions corresponds to a “control unit” in the present disclosure.

(Display Control Processing)

FIG. 3 is a flow chart illustrating an example of a flow of display control processing. The display control processing illustrated in FIG. 3 is started, for example, by using as a trigger an event in which the information processing apparatus 1 obtains information of an advertisement (hereinafter, also referred to as advertisement information) to be displayed on the outer surface of the vehicle.

In step S11, the display unit 101 displays the advertisement information thus obtained on the display (the output unit 15) formed on the outer surface of the vehicle. The advertisement information is not limited to the case where it is displayed on the display, but may be outputted as sound from an external speaker mounted on the vehicle. Here, note that in cases where the driver of the following vehicle gives a consent, the advertisement information may be transmitted to the following vehicle by vehicle-to-vehicle communications, so that it can be outputted by voice from an internal speaker arranged in the following vehicle. The consent of the driver of the following vehicle can be obtained through the vehicle-to-vehicle communications or the screen of a vehicle navigation system.

The display unit 101 can obtain the advertisement information from the advertisement information database 111. The display unit 101 may obtain the advertisement information at a predetermined time interval. In addition, the display unit 101 may obtain the advertisement information each time the vehicle runs a predetermined distance.

Here, the advertisement information stored in the advertisement information database 111 will be explained according to FIG. 4. FIG. 4 is a view illustrating an example of an advertisement information table. The advertisement information table is a table for managing the information to be displayed on the outer surface of the vehicle for each advertisement object. The advertisement information table has fields of advertisement object, display object area, advertisement image, and advertisement video.

The advertisement object field stores restaurant facilities, amusement facilities, accommodation facilities, public facilities, etc., which are the objects to be advertised (advertisement objects). The display object area field stores areas where the vehicle displays advertisements with respect to these facilities. During running in a display object area, the vehicle need only display the advertisements on facilities in that area. That is, the vehicle need only obtain the advertisement information with the current position thereof included in the display object area, and display it on the display. In cases where advertisement information on a plurality of facilities are obtained, the display unit 101 can switch and display the advertisement of each facility at every predetermined period of time, for example. In addition, the display unit 101 may decide the advertisement to be displayed according to the attributes of the driver of the following vehicle. The attributes of the driver of the following vehicle are information such as for example sex, age, the number of fellow passengers, the attributes of the fellow passengers, etc., and are obtained from the following vehicle by means of vehicle-to-vehicle communications. The advertisement image field stores data of still images containing advertisement information on facilities. The advertisement video field stores video data for introducing and advertising facilities.

Here, note that the display unit 101 may obtain advertisement information from the external server which provides the advertisement information through a network such as the Internet, etc. In this case, the display unit 101 may request the advertisement information to the external server at a predetermined timing, or may receive advertisement information distributed in a periodic manner from the external server.

In step S12, the determination unit 102 obtains, from the sensors of the vehicle or external sensors arranged outside the vehicle, the measurement information measured by each sensor. The determination unit 102 obtains, as the measurement information, for example, information on the speed or acceleration of the vehicle from an acceleration sensor. In addition, the determination unit 102 can obtain information on an inter-vehicle distance between the vehicle and the following vehicle from a distance sensor. Moreover, the determination unit 102 can also obtain information on traffic congestion in front of the vehicle from the external sensors. The determination unit 102 may store the measurement information thus obtained in the measurement information database 112.

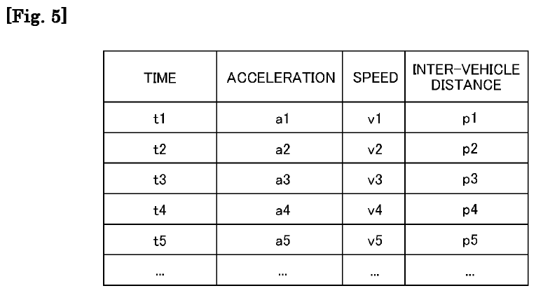

Here, the measurement information stored in the measurement information database 112 will be explained according to FIG. 5. FIG. 5 is a view illustrating an example of a measurement information table. The measurement information table stores the measurement information obtained by the determination unit 102 from the sensors of the vehicle or the external sensors. The measurement information stored in the measurement information table is used for determining whether an event affecting the running of the vehicle has occurred. The measurement information table exemplified in FIG. 5 can store measurement information measured at a predetermined time interval. In addition, the measurement information table has fields of time point, acceleration, speed, and inter-vehicle distance.

The time point field stores time points at which measurements were carried out by the sensors of the vehicle or the external sensors. The acceleration field and the speed field store the acceleration and speed of the vehicle at each measured time point, respectively. The inter-vehicle distance field stores the inter-vehicle distance between the vehicle and the following vehicle at each measured time point.

Here, the inter-vehicle distance between the vehicle (own vehicle) and the following vehicle can be measured by a rear distance sensor or a millimeter wave radar mounted on the own vehicle. In addition, the inter-vehicle distance between the vehicle and the following vehicle is calculated from the position of the own vehicle and the position of the following vehicle. The position of the following vehicle can be obtained through vehicle-to-vehicle communications by location information which is broadcast by each vehicle periodically every 0.1 second, for example. Moreover, the inter-vehicle distance between the vehicle and the following vehicle can also be obtained by a measured value of a front distance sensor mounted on the following vehicle which is received by the own vehicle through vehicle-to-vehicle communications.

The measurement information table is not limited to the example illustrated in FIG. 5, but may have fields which store the traffic congestion, the presence or absence of obstacles, the condition of the road surface, etc., at each measured time point. In addition, the measurement information may be measured at different time intervals for each sensor, and the measurement information may be stored in individual tables for each sensor.

In step S13, the determination unit 102 determines, based on the measurement information obtained in step S12, whether an event affecting the running of the vehicle has occurred. In cases where the vehicle is braked suddenly, for example, the determination unit 102 can make a determination that an event affecting the running of the vehicle has occurred. The condition that the vehicle is braked suddenly can be predicted or detected by the fact that the rate of decrease of the acceleration obtained in step S12 has become equal to or more than a predetermined threshold value.

In addition, in cases where traffic congestion or an obstacle is detected in front of the vehicle, for example, the determination unit 102 can make a determination that an event affecting the running of the vehicle has occurred. The determination unit 102 can detect traffic congestion in front of the vehicle, for example, based on information from an external sensor or VICS (registered trademark) (Vehicle Information and Communication System). In addition, the determination unit 102 can detect an obstacle such as a pedestrian or the like, by the analysis of images taken by a vehicle mounted camera, or by means of millimeter wave radar sensing.

Moreover, in cases where the inter-vehicle distance between the vehicle and the following vehicle has decreased rapidly, for example, the determination unit 102 can make a determination that an event affecting the running of the vehicle has occurred. The condition that the inter-vehicle distance between the vehicle and the following vehicle has decreased rapidly can be detected by the fact that the rate of decrease per unit time of the inter-vehicle distance obtained in step S12 has become equal to or more than a predetermined threshold value. The rate of decrease of the inter-vehicle distance is a ratio of an amount of decrease of the inter-vehicle distance with respect to the inter-vehicle distance.

A method of determining whether an event affecting the running of the vehicle has occurred is not limited to the above-mentioned example. The determination unit 102 can determine whether an event affecting the running of the vehicle has occurred, based on the measurement information such as the change of a traffic signal, the presence or absence of an intersection or crossing, the distance to a front or preceding vehicle or a parallel (side) vehicle, the state of a road surface, etc., which can be measured by the sensors of the vehicle or the external sensors.

In cases where it is determined that an event affecting the running of the vehicle has occurred (Yes in step S13), the processing or routine goes to step S14. On the other hand, in cases where it is determined that an event affecting the running of the vehicle has not occurred (No in step S13), the routine returns to step S12, and the determination unit 102 continuously obtains the measurement information from the sensors until an event affecting the running of the vehicle is detected.

In step S14, the changing unit 103 changes the display mode of the advertisement. The changing unit 103 can interrupt the display of the advertisement, or can switch it to a display of attention, for example. In addition, in cases where the advertisement is displayed in video, the changing unit 103 may change the display mode into an advertisement with still image.

### Advantages of the First Embodiment

In the first embodiment, the information processing apparatus 1 obtains measurement information from the sensors of the vehicle or the external sensors. The information processing apparatus 1 determines, based on the measurement information thus obtained, whether an event affecting the running of the vehicle has occurred. In cases where an event affecting the running of the vehicle has occurred, the information processing apparatus 1 changes the display mode of the advertisement by interrupting the display of the advertisement or making the display of attention. With this, it becomes possible for the information processing apparatus 1 to bring attention about a surrounding situation to the driver of the following vehicle or passers-by. In addition, in cases where an event affecting the running of the vehicle has not occurred, the information processing apparatus 1 can distribute the advertisement in an effective manner, by making use of the outer surface of the vehicle as an advertising medium.

### Modification of the First Embodiment

In the first embodiment, the information processing apparatus 1 changes the display mode of the advertisement, in cases where it is determined, based on the measurement information obtained from the sensors of the vehicle or the external sensors, that an event affecting the running of the vehicle has occurred. In this modification, further, the information processing apparatus 1 calculates the degree of influence with respect to the running of the vehicle by scoring each event around the vehicle in a stepwise manner based on the obtained measurement information. The information processing apparatus 1 changes the display mode of the advertisement according to the degree of influence thus calculated.

For example, in cases where the vehicle is braked suddenly, the determination unit 102 evaluates the influence level of acceleration by scores from 1 to 3 according to the value of the rate of decrease of the acceleration. In addition, it is considered that as the acceleration decreases, the inter-vehicle distance between the vehicle and the following vehicle also decreases, so the determination unit 102 evaluates the influence level of the inter-vehicle distance by scores from 1 to 3 according to the value of the rate of decrease of the inter-vehicle distance. Then, the determination unit 102 can calculate a total score of the influence levels of the acceleration and the inter-vehicle distance, and can use the total score thus obtained as the degree of influence. Thus, by calculating the degree of influence in this manner, the determination unit 102 can score the degree of influence from 0 to 6 in a stepwise manner.

The changing unit 103 changes the display mode of the advertisement according to the degree of influence calculated by the determination section 102. For example, in cases where the degree of influence is from 0 to 2, the changing unit 103 switches from the display of the advertisement with video data to the display of advertisement with still image. By switching from video to still image, the occupation of the consciousness of the driver of the following vehicle by the advertisement is avoided. In addition, in cases where the degree of influence is 3 or 4, the changing unit 103 interrupts the display of the advertisement with video data or the display of the advertisement with still image. Moreover, in cases where the degree of influence is 5 or 6, the changing unit 103 switches the display of the advertisement with video data or the display of advertisement with still image to the display of attention. Thus, the changing unit 103 can change the display mode according to the degree of influence.

Here, there has been illustrated an example in which the degree of influence is calculated based on the measurement information on the acceleration and the inter-vehicle distance, but the present disclosure is not limited to this. The changing unit 103 may calculate the degree of influence based on either one of the acceleration, the inter-vehicle distance and other measurement information, or may also calculate the degree of influence, by combining a plurality of these pieces of measurement information with one another.

In this modification, the information processing apparatus 1 can calculate the degree of influence by events around the vehicle based on measurement information obtained from the sensors of the vehicle or the external sensors, and can change the display mode according to the degree of influence thus calculated. For this reason, the information processing apparatus 1 can switch the display mode in a stepwise manner according to the situation around the vehicle.

### Second Embodiment

In the above-mentioned first embodiment, the information processing apparatus 1 determines whether an event affecting the running of the vehicle has occurred, and changes the display mode of an advertisement, by interrupting the display of the advertisement or changing it to a display content to bring up attention. In this second embodiment, the information processing apparatus 1 further changes the display mode of the advertisement in consideration of the visibility from the following vehicle according to the inter-vehicle distance between the vehicle and the following vehicle. For example, the information processing apparatus 1 changes the display mode of the advertisement, by making the size of the display content larger when the inter-vehicle distance between the vehicle and the following vehicle becomes longer, as well as by making the size of the display content smaller when the inter-vehicle distance becomes shorter.

Here, note that, in the second embodiment, the processing of determining whether an event affecting the running of the vehicle has occurred can be omitted, and the display mode of an advertisement can be changed according to the inter-vehicle distance between the vehicle and the following vehicle. That is, the information processing apparatus 1 according to the second embodiment may display an advertisement on the outer surface of the vehicle, obtain the inter-vehicle distance between the vehicle and the following vehicle, and change the display mode of the advertisement so as to change the size of the display of the advertisement or to interrupt the display of the advertisement, according to the inter-vehicle distance.

The basic configuration of the information processing apparatus 1 according to the second embodiment is the same as that of the first embodiment, and the display control processing carried out by the information processing apparatus 1 according to the second embodiment is different from that according to the first embodiment. In the following, differences of this second embodiment from the first embodiment will be mainly explained. Here, note that the display control processing of the second embodiment may be carried out in parallel with the display control processing of the first embodiment.

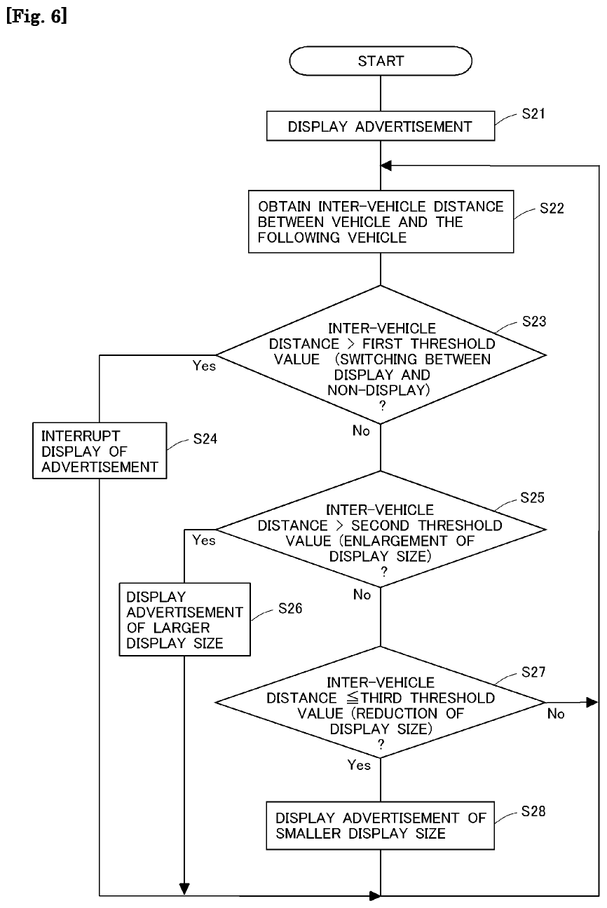

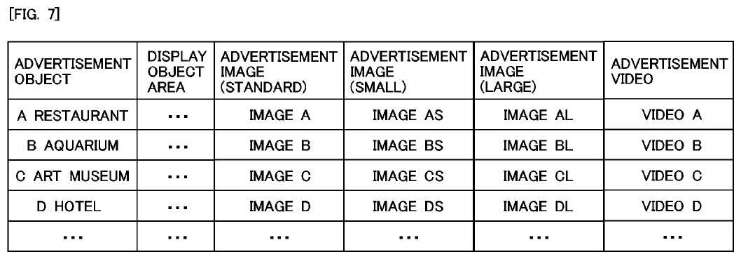

FIG. 6 is a flow chart illustrating an example of a flow of the display control processing according to the second embodiment of the present disclosure. The display control processing illustrated in FIG. 6 is started, for example, by using, as an opportunity or a trigger, an event that the inter-vehicle distance between the vehicle and the following vehicle becomes a predetermined threshold value. The predetermined threshold value is assumed to be a distance at which a crew member of the following vehicle can recognize that the advertisement is displayed on the display of the (preceding) vehicle.

In step S21, the display unit 101 obtains advertisement information, and displays it on the display (the output unit 15) formed on the outer surface of the vehicle. The display unit 101 can obtain the advertisement information from the advertisement information database 111.

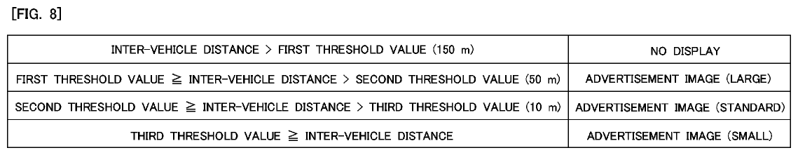

Here, the advertisement information stored in the advertisement information database 111 according to the second embodiment will be explained according to FIG. 7. FIG. 7 is a view illustrating an example of an advertisement information table according to the second embodiment. The advertisement information table is a table for managing the information to be displayed on the outer surface of the vehicle for each advertisement object. The advertisement information table according to the second embodiment has a field of advertisement image (small) and a field of advertisement image (large), in addition to the same fields as those in the advertisement information table illustrated in FIG. 4. An advertisement image (standard) field in the advertisement information table of FIG. 7 corresponds to the advertisement image field in the advertisement information table of FIG. 4. In step S21, the display unit 101 need only first display an advertisement image (standard) on the display.

The advertisement image (small) field stores the advertisement images which display the same contents as those of advertisement images stored in the advertisement image (standard) field, with smaller characters and images. The advertisement images (small) are displayed, in cases where the vehicle is stopped, or in cases where the inter-vehicle distance between the vehicle and the following vehicle becomes short. The advertisement images (small) may include a larger amount of information than the advertisement images (standard) does.

The advertisement image (large) field stores the advertisement images which display the same contents as those of advertisement images stored in the advertisement image (standard) field, with larger characters and images. The advertisement images (large) are displayed, in cases where the inter-vehicle distance between the vehicle and the following vehicle becomes longer. The advertisement images (large) may have a smaller amount of information included than the advertisement images (standard) so as to make it possible to grasp the contents thereof even from a far distance.

In step S22, the determination unit 102 obtains, as measurement information, the inter-vehicle distance between the vehicle and the following vehicle measured by a distance sensor mounted on the vehicle. The determination unit 102 may store the measurement information thus obtained in the measurement information database 112, together with information of measured time.

In step S23 through step S28, the determination unit 102 determines how to change the display mode of the advertisement, based on the inter-vehicle distance obtained in step S22. The determination unit 102 can obtain a correspondence relation between the inter-vehicle distance and the display mode of the advertisement from the measurement information database 112.

Here, the correspondence information between the inter-vehicle distance and the display mode of the advertisement stored in the measurement information database 112 will be explained according to FIG. 8. FIG. 8 is a view illustrating an example of a correspondence relation definition table between the inter-vehicle distance and the display mode of an advertisement. The correspondence relation definition table defines what kind of display mode of the advertisement is to be displayed according to a threshold value for the inter-vehicle distance between the vehicle and the following vehicle.

In the example of the correspondence relation definition table illustrated in FIG. 8, in cases where the inter-vehicle distance is longer than a first threshold value (e.g., 150 m), no advertisement is displayed. In addition, in cases where the inter-vehicle distance is equal to or less than the first threshold value and is longer than a second threshold value (e.g., 50 m), an advertisement image (large) of the advertisement information table is displayed. Moreover, in cases where the inter-vehicle distance is equal to or less than the second threshold value and is longer than a third threshold value (e.g., 10 m), an advertisement image (small) of the advertisement information table is displayed.

In step S23, the determination unit 102 determines whether the inter-vehicle distance between the vehicle and the following vehicle 2 is longer than the first threshold value. The first threshold value is to switch over between the display of the advertisement and the non-display of the advertisement. In the example of FIG. 8, the first threshold value is 150 m, and hence, the determination unit 102 need only determine whether the inter-vehicle distance is longer than 150 m. In cases where the inter-vehicle distance between the vehicle and the following vehicle is longer than the first threshold value (Yes in step S23), the processing or routine goes to step S24. On the other hand, in cases where the inter-vehicle distance between the vehicle and the following vehicle is equal to or less than the first threshold value (No in step S23), the routine goes to step S25. In step S24, the changing unit 103 interrupts the display of the advertisement, and the routine returns to step S22.

In step S25, the determination unit 102 determines whether the inter-vehicle distance between the vehicle and the following vehicle 2 is longer than the second threshold value. The second threshold value is to enlarge the size of the display of the advertisement (hereinafter, referred to as a display size). In the example of FIG. 8, the second threshold value is 50 m, and hence, the determination unit 102 need only determine whether the inter-vehicle distance is longer than 50 m. In cases where the inter-vehicle distance between the vehicle and the following vehicle is longer than the second threshold value (Yes in step S25), the processing or routine goes to step S26. On the other hand, in cases where the inter-vehicle distance between the vehicle and the following vehicle is equal to or less than the second threshold value (No in step S25), the routine goes to step S27.

In step S26, the changing unit 103 displays advertisement information stored in the advertisement image (large) field on the display by referring to the advertisement information table, and the processing or routine returns to step S22.

In step S27, the determination unit 102 determines whether the inter-vehicle distance between the vehicle and the following vehicle 2 is shorter than the third threshold value. The third threshold value is to reduce the display size of the advertisement. In the example of FIG. 8, the third threshold value is 10 m, and hence, the determination unit 102 need only determine whether the inter-vehicle distance is equal to or less than 10 m. In cases where the inter-vehicle distance between the vehicle and the following vehicle is equal to or less than the third threshold value (Yes in step S27), the processing or routine goes to step S28. On the other hand, in cases where the inter-vehicle distance between the vehicle and the following vehicle is longer than the third threshold value (No in step S27), the routine returns to step S22, without changing the display mode of the advertisement.

In step S28, the changing unit 103 displays advertisement information stored in the advertisement image (small) field on the display by referring to the advertisement information table, and the processing or routine returns to step S22.

Here, note that the above-mentioned example has explained the case where different image data is displayed according to the inter-vehicle distance between the vehicle and the following vehicle, but the present disclosure is not limited to this. The changing unit 103 can also change the display mode by displaying the same image in an enlarged scale or in a reduced scale. In addition, the data displayed on the display according to the inter-vehicle distance may be still images, or may be video data.

In the second embodiment, the information processing apparatus 1 changes the display mode of an advertisement by displaying the advertisement of different display sizes according to the inter-vehicle distance between the vehicle and the following vehicle. With this, even in cases where the inter-vehicle distance between the vehicle displaying the advertisement and the following vehicle changes, the crew member of the following vehicle can see the advertisement of a suitable display size.

### OTHER EMBODIMENTS

The above-mentioned embodiments and modifications are only some examples, and the present disclosure can be implemented while being changed or modified suitably without departing from the spirit and scope of the present disclosure.

In addition, the configurations and processings explained in this disclosure can be implemented in various combinations thereof, as long as technical inconsistency does not occur.

Moreover, the processing(s) explained as carried out by a single apparatus may be carried out by a plurality of apparatuses. Alternatively, the processing(s) explained as carried out by different apparatuses may be carried out by a single apparatus. In a computer system, whether each function of the present disclosure is achieved by what kind of hardware configuration (server configuration) can be changed in a flexible manner.

The present disclosure can also be achieved by supplying a computer program to a computer which implements the functions explained in the above-mentioned embodiments and modifications, and by reading out and executing the program by means of one or more processors of the computer. Such a computer program may be supplied to the computer by a non-transitory computer readable storage medium which can be connected with a system bus of the computer, or may be supplied to the computer through a network. The non-transitory computer readable storage medium, for example, an arbitrary type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, an arbitrary type of medium suitable for storing electronic commands.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus comprising a controller including at least one processor,
the controller configured to execute:
displaying an advertisement on an outer surface of a vehicle;
determining whether there has occurred an event affecting the running of the vehicle, based on measurement information obtained from a sensor mounted on the vehicle or an external sensor arranged outside the vehicle; and
changing a display mode of the advertisement in cases where it is determined that the event has occurred.

2. The information processing apparatus according to claim 1, wherein
in cases where the vehicle is braked suddenly, the controller makes a determination that the event has occurred.

3. The information processing apparatus according to claim 1, wherein
in cases where traffic congestion or an obstacle has been detected in front of the vehicle, the controller makes a determination that the event has occurred.

4. The information processing apparatus according to claim 1, wherein
in cases where a rate of decrease per unit time of the inter-vehicle distance between the vehicle and the following vehicle becomes equal to or more than a threshold value, the controller makes a determination that the event has occurred.

5. The information processing apparatus according to claim 1, wherein
in cases where it is determined that the event has occurred, the controller changes the display mode of the advertisement so as to interrupt the display of the advertisement, or to make a display of attention.

6. The information processing apparatus according to claim 1, wherein
the controller calculates a degree of influence by the event around the vehicle from the measurement information, and changes the display mode of the advertisement according to the degree of influence.

7. The information processing apparatus according to claim 1, wherein
the controller obtains the inter-vehicle distance between the vehicle and the following vehicle as the measurement information, and changes the display mode so as to change the size of the display of the advertisement or to interrupt the display, according to the inter-vehicle distance.

8. An information processing method causing a computer to execute:
a step of displaying an advertisement on an outer surface of a vehicle;
a step of determining whether there has occurred an event affecting the running of the vehicle, based on measurement information obtained from a sensor mounted on the vehicle or an external sensor arranged outside the vehicle; and
a step of changing a display mode of the advertisement in cases where it is determined that the event has occurred.

9. A non-transitory storage medium stored with an information processing program,
the information processing program configured to cause a computer to execute:
a step of displaying an advertisement on an outer surface of a vehicle;
a step of determining whether there has occurred an event affecting the running of the vehicle, based on measurement information obtained from a sensor mounted on the vehicle or an external sensor arranged outside the vehicle; and
a step of changing a display mode of the advertisement in cases where it is determined that the event has occurred.
